(19) United States
(12) Patent Application Publication
(10) Pub. No.: US 2008/0056466 A1
(43) Pub. Date: Mar. 6, 2008

(54) Method of Responding to an Incoming Call

(76) Inventor: Ken A. Nishimura, Fremont, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/469,146

(22) Filed: Aug. 31, 2006

(51) Int. Cl. H04M 1/64

(52) U.S. Cl. 379/88.22

(57) ABSTRACT

An incoming call destined for a personal voice communication device is responded to by providing a user alert in response to the incoming call and performing a courtesy hold process. In the courtesy hold process, the incoming call is answered, a courtesy hold message is sent as a response to the incoming call and, at the end of the courtesy hold message, the incoming call is put temporarily on hold. The courtesy hold process allows a recipient located in a telephone conversation-inappropriate location to answer the incoming call without needing to speak and then, while the incoming call is on hold, to move to a location where a telephone conversation would be appropriate to take the call. The call responding process may be performed by the recipient's personal voice communication device or by an intermediate communication device with which the recipient's personal voice communication device is in communication.

### BACKGROUND

Personal voice communication devices (e.g., cell phones, PDAs with voice capability, cordless telephones) have become ubiquitous. While the utility of such devices is obvious, using such devices in circumstances regarded by others as inappropriate has resulted in societal friction.

Many solutions have been incorporated in personal voice communication devices in an attempt to alleviate such problems. Such solutions include silent ringers (vibrators or lights), caller-specific ring tones, voice mail, etc. However, since the caller typically does not know the recipient's circumstances when originating a call, it is a common occurrence for a recipient to receive an incoming call in a location inappropriate for a telephone conversation, i.e., a telephone conversation-inappropriate location. Nevertheless, a ringing personal voice communication device is so compelling to the recipient and, if audible, disruptive to those in the recipient's presence that the recipient will answer the incoming call rather than letting the incoming call be forwarded to voice mail.

Currently, a recipient who receives an incoming call in circumstances inappropriate for a conversation has two main options, neither of which is entirely satisfactory. In a first option, the recipient lets the incoming call be forwarded to voice mail. The recipient then picks up the message, if any, later and attempts to return the call. This option is often unsatisfactory: the incoming call may have been important, the caller may not leave a message, or both parties may be frustrated by the need to play another round of “telephone tag.” In the event that the recipient has forgotten to turn off the personal voice communication device or otherwise set the ringer to its silent mode before entering a telephone conversation-inappropriate location, this option may additionally involve the recipient frantically trying to turn the personal voice communication device off, or otherwise trying to silence the ringer, to reduce the disruption caused by the incoming call.

In a second option, the recipient answers the incoming call while at the same time trying to excuse him/herself and move to a location more appropriate for a telephone conversation. The terse initial conversation, followed by a hurried exit, still causes significant disruption even when the personal voice communication device's ringer is muted.

What is needed, therefore, is a way of responding to an incoming call destined for a personal voice communication device that is more courteous towards the caller and those in the presence of the recipient than current ways of responding to an incoming call.

### BRIEF DESCRIPTION OF THE DRAWINGS

FIG. 1 is a flow chart showing an example of a method in accordance with an embodiment of the invention for responding to an incoming call destined for a personal voice communication device.

FIG. 2 is a flow chart showing an example of a method in accordance with an embodiment of the invention in which the courtesy hold process is performed in response to a user input.

FIG. 3 is a flow chart showing an example of a method in accordance with an embodiment of the invention in which the courtesy hold process is performed automatically in response to each incoming call.

FIG. 4 is a flow chart showing an example of a method in accordance with an embodiment of the invention in which the courtesy hold process is performed automatically but can be cancelled by a user input.

FIG. 5 is a block diagram showing an example of a personal voice communication device in accordance with an embodiment of the invention.

FIG. 6 is a block diagram showing an example of an audio module that may be used in the example of the personal voice communication device described above with reference to FIG. 5.

FIG. 7 is a block diagram showing an example of an intermediate communication device in accordance with an embodiment of the invention.

FIG. 8 is a flow chart showing an example of a method in accordance with an embodiment of the invention for responding to an incoming call destined for a personal voice communication device embodied as a point-to-point wireless communication device.

FIG. 9 is a flow chart showing an example of a method in accordance with an embodiment of the invention in which the courtesy hold message is sent in response to a user input.

### DETAILED DESCRIPTION

Embodiments of the invention provide a method of responding to an incoming call destined for a personal voice communication device. Other embodiments of the invention provide a personal voice communication device that performs a method in accordance with an embodiment the invention. Yet other embodiments of the invention provide an intermediate communication device that performs an embodiment of a method in accordance with an embodiment of the invention.

As used in this disclosure, a personal voice communication device is any device capable of providing an end of a wireless voice communication path that extends between a caller and a recipient. In some embodiments, the wireless voice communication path extends directly between caller and recipient. In other embodiments, the wireless voice communication path extends from caller to recipient via at least one intermediate communication device. A wireless communication path need not be wireless through its entire extent between caller and recipient. Only part of the wireless voice communication path, typically the part between the recipient's personal voice communication device and a base station, is wireless. The remainder of the communication path can be provided by electrical, optical or other types of communication links.

As noted above, in some embodiments, the communication path between caller and recipient passes through at least one intermediate communication device. An intermediate communication device is any device through which the communication path between caller and recipient passes and that is capable of sending system signals to, and responding to system signals received from, personal voice communication device 200. System signals are control signals different from voice, audio, picture and video signals that typically additionally pass between the intermediate communication device and the personal voice communication device. Examples of an intermediate communication device include, but are not limited to, a central office and a base station. Examples of a base station include, but are not limited to, the base station of cellular telephone system and the base station of a cordless telephone. The cordless telephone base station is typically connected to a conventional switched telephone network. However, the base station of a voice over internet protocol (VOIP) cordless telephone is connected directly or indirectly to a packet-based network, e.g., the Internet.

In an example of a method in accordance with an embodiment of the invention for responding to an incoming call destined for a personal voice communication device, a user alert is provided in response to the incoming call and a courtesy hold process is performed. In the courtesy hold process, the incoming call is answered, a courtesy hold message is sent as a response to the incoming call and, at the end of the courtesy hold message, the incoming call is temporarily put on hold.

The courtesy hold process allows a recipient located in a telephone conversation-inappropriate location to receive the incoming call while causing less disruption than if a conventional incoming call receiving process were used. The user alert informs the recipient that the personal voice communication device has received an incoming call. Disruption is minimized when the user alert is a so-called silent user alert, such as a vibrator or a light. The courtesy hold process answers the incoming call, which prevents the incoming call from being forwarded to voice mail. Answering the incoming call also establishes communication with the caller, which allows the courtesy hold message to be sent to the caller. The courtesy hold message advises the caller that the recipient is temporarily unavailable to take the call, but will be available shortly, and asks the caller to remain on the line. The courtesy hold message saves the recipient from having to speak in the telephone conversation-inappropriate location to respond to the incoming call. The courtesy hold process then puts the incoming call on hold. This gives the recipient, who has been alerted by the silent user alert, time to exit gracefully from the telephone conversation-inappropriate location and move to a location where a telephone conversation would be appropriate. Once at such location, the recipient provides to the personal voice communication device a pick-up user input that causes the incoming call to be taken off hold and connects the caller to the recipient, whereupon a conversation can ensue.

If the recipient is unable to pick up the incoming call within a predetermined waiting time, an embodiment of the courtesy hold process additionally forwards the incoming call to an alternative recipient, such as a receptionist, an assistant, an alternative number, or a voice mail service. Forwarding the incoming call can be preceded by an additional courtesy hold message, this one apologizing for the recipient's failure to take the incoming call as promised.

In embodiments of the method, the courtesy hold process has two principal performance modes, an automatic performance mode in which the courtesy hold process is performed automatically in response to each incoming call, and a manual performance mode in which the courtesy hold process is performed in response to a user input provided after each incoming call has been received. In some embodiments, the method can be set so that the automatic performance mode, the manual performance mode, or neither performance mode is a default performance mode. The personal voice communication device may be provided with one or more user inputs that allow the user to select the performance mode of the courtesy hold process, or allow the user to change the default performance mode, or both.

In the automatic performance mode, the courtesy hold process is performed automatically in response to each incoming call. Optionally, setting the performance mode to automatic additionally automatically sets the user alert to its silent mode. This removes the need for the recipient to remember to set the user alert to its silent mode before becoming entering a telephone conversation-inappropriate location, and eliminates the disruption forgetting to do this would cause.

In the manual performance mode, after the user alert has been provided in response to the incoming call, the call responding method waits for the user to provide a courtesy hold user input. The courtesy hold process executes only after the courtesy hold user input has been received. The manual performance mode allows the recipient to decide whether to answer the incoming call using the courtesy hold process or simply to let the incoming call be forwarded into an alternative recipient. The incoming call is typically forwarded to the alternative recipient if the original recipient does not provide the courtesy hold user input within a predetermined waiting time. Typically, on receiving the incoming call, the personal voice communication device displays a caller identification to assist the recipient to decide whether to provide the courtesy hold user input. In response to the user alert, the recipient checks the caller identification display and decides whether to provide the courtesy hold user input to initiate the courtesy hold process.

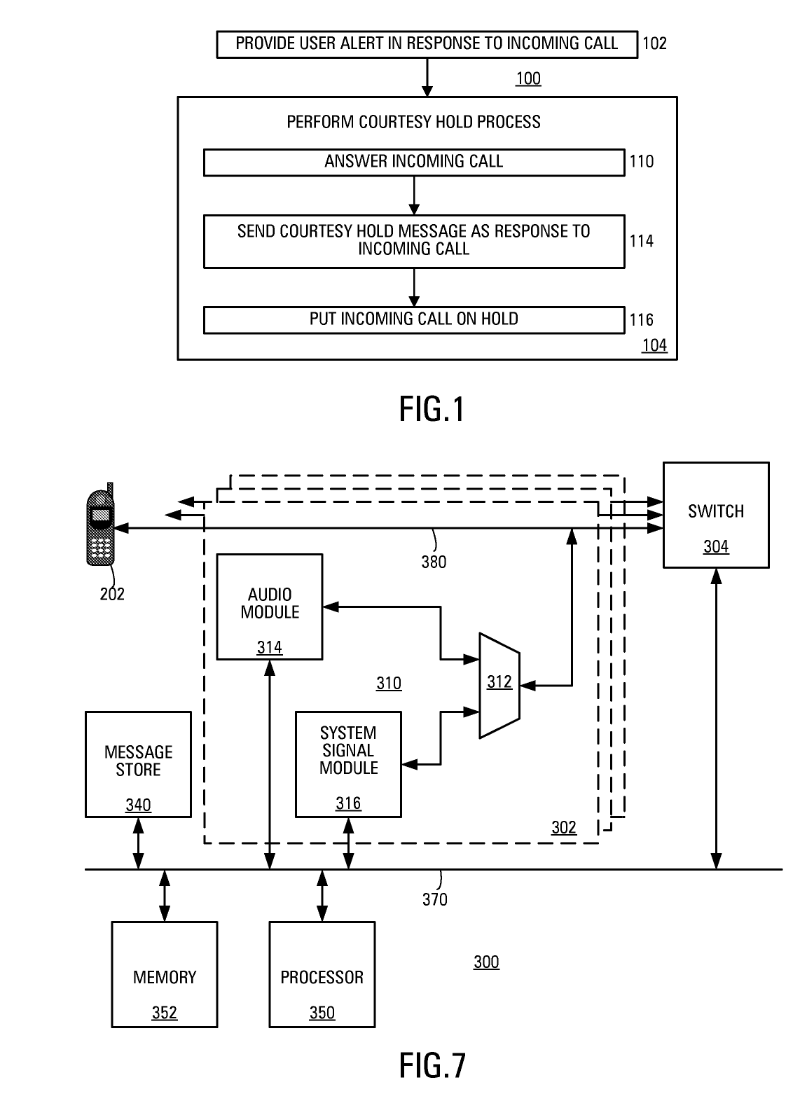

FIG. 1 is a flow chart showing an example of a method 100 in accordance with an embodiment of the invention for responding to an incoming call destined for a personal voice communication device. In block 102, a user alert is provided in response to the incoming call and, in block 104, a courtesy hold process is performed. The courtesy hold process comprises blocks 110, 114 and 116.

In the courtesy hold process, in block 110, the incoming call is answered. In block 114, a courtesy hold message is sent in response to the incoming call. In block 116, the incoming call is temporarily put on hold.

One embodiment of method 100 is performed by the personal voice communication device. Another embodiment is performed by an intermediate communication device in the communication path between the caller and the recipient. For example, such embodiment may be performed by the central office that switches the incoming call to the recipient's personal voice communication device. Yet another embodiment is performed in part by the intermediate communication device and in part by the personal voice communication device. Yet another embodiment is performed in part by one intermediate communication device and in part by another intermediate communication device.

The user alert alerts the recipient to the incoming call so that the recipient can move from the telephone call-inappropriate location to a location where a telephone conversation would be appropriate. In the courtesy hold process, answering the incoming call establishes communication with the caller so that the courtesy hold message can be sent to the caller as a response to the incoming call. The courtesy hold message informs the caller that his/her call has been answered by a courtesy hold process. One purpose of the courtesy hold message is to prevent the caller from hanging up.

Typically, the courtesy hold message is a verbal message that informs the caller that his/her call has not been forwarded to voice mail, and that the recipient will be available shortly, typically, within one minute, to take the call. The verbal message may be preceded by an audible cue intended to distinguish the courtesy hold message from a conventional voice mail outgoing message.

It is envisaged that, once personal voice communication devices and intermediate communication devices equipped to respond to incoming calls with a courtesy hold process become ubiquitous and callers become used to having their calls answered by a courtesy hold process, the verbal message could be dropped. In this case, the audible cue would constitute the entire courtesy hold message.

Putting the incoming call temporarily on hold after the courtesy hold message has been sent as a minimum maintains communication at least between the caller and the device in the communication path between caller and recipient that has put the incoming call on hold. In embodiments in which the incoming call is put on hold by the recipient's personal voice communication device, putting the incoming call temporarily on hold maintains communication between the personal voice communication device and the caller.

The incoming call remains on hold until the recipient provides a pick-up user input to the personal voice communication device. The recipient provides the pick-up user input once he/she has moved to a location where a telephone conversation would be appropriate. The pick-up user input causes the personal voice communication device or the intermediate communication device, whichever has the incoming call on hold, to take the incoming call off hold. This puts the caller and the recipient in voice communication with one another.

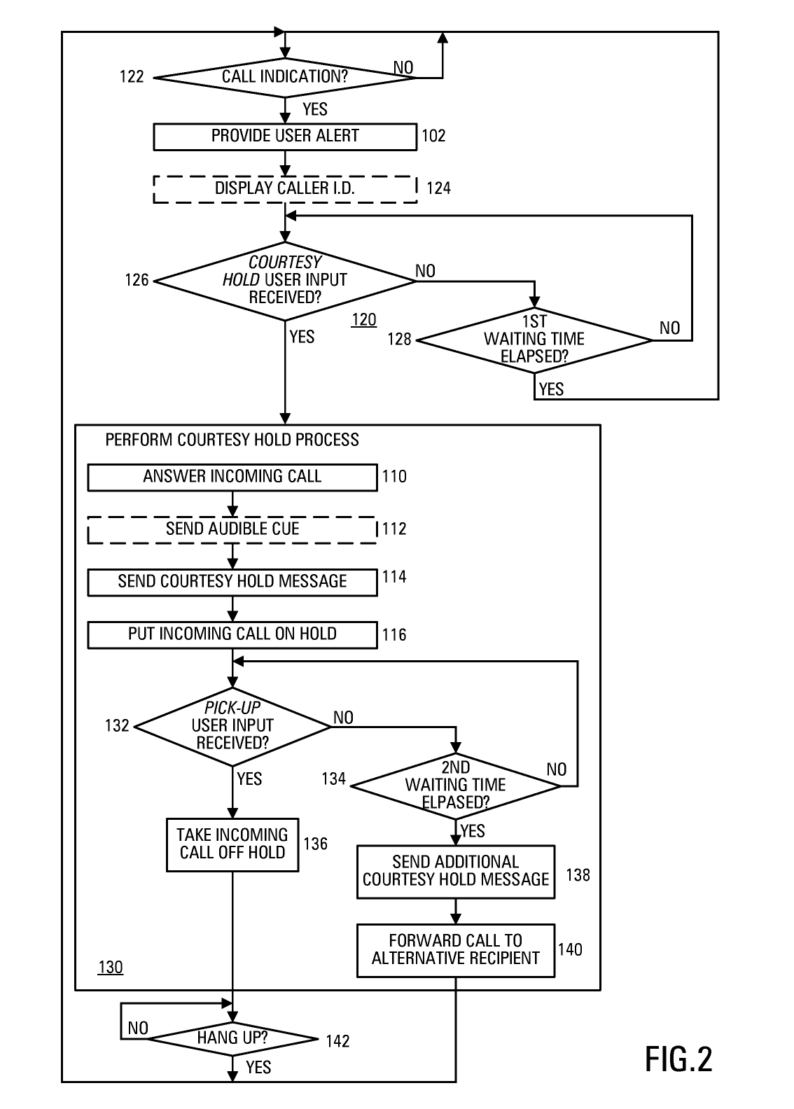

As noted above, the courtesy hold process may be performed automatically or in response to a user input. FIG. 2 is a flow chart showing an example of a method 120 in accordance with an embodiment of the invention in which the courtesy hold process is performed in response to a user input. Elements of method 120 that correspond to elements of method 100 described above with reference to FIG. 1 are indicated using the same reference numerals and will not be described again here.

Execution begins at block 122, where a test is performed to determine whether an incoming call indication has been received. The incoming call indication is indicative of an incoming call. A NO result returns execution to block 122, typically after a delay (not shown). A YES result causes execution to advance to block 102. In some embodiments, the incoming call indication is a conventional ring signal received by the personal voice communication device. More typically, the incoming call indication is a digital signal received by the recipient's personal voice communication device or by an intermediate communication device and having a state that indicates an incoming call.

In block 102, a user alert is provided. In an embodiment of the method performed by the personal voice communication device, the personal voice communication device provides the user alert directly by providing a recipient-perceptible user alert, i.e., a user alert, such as a ring tone, a vibration or a light, perceptible by the recipient. In an embodiment of the method performed by an intermediate communication device, the intermediate communication device provides the user alert indirectly by providing an incoming call indication to the recipient's personal voice communication device. In response to the incoming call indication, the personal voice communication device generates a recipient-perceptible user alert. In either case, disruption is minimized when the recipient-perceptible user alert is a so-called silent user alert such as a vibration or a light.

In block 124, performance of which is optional, the personal voice communication device's caller ID system (not shown) displays information indicating the identity of the caller. The user alert provided in block 102 informs the recipient that an incoming call has been received and the caller identification provided in block 124 indicates the identity of the caller. Displaying the identity of the caller helps the recipient decide whether to provide a courtesy hold user input to activate the courtesy hold process. Caller identification may additionally or alternatively be provided by a distinctive caller-specific or caller group-specific user alert provided in block 102.

In block 126, a test is performed to determine whether a courtesy hold user input has been received. A NO result causes execution to advance to block 128, described next. A YES result causes execution to advance to block 130, where the courtesy hold process is performed. The courtesy hold process will be described in detail below.

In block 128, a test is performed to determine whether a first waiting time has elapsed. The first waiting time defines the maximum time allowed for the recipient to provide the courtesy hold user input. A NO result causes execution to return to block 126, typically via a delay (not shown). A YES result causes execution to return to block 122 to await the next incoming call indication. Execution may return to block 122 via a test that determines whether the incoming call indication has been discontinued to prevent blocks 122, 102, 126 and 128 from being performed again in response to the same incoming call.

Typically, an intermediate communication device in the communication path between caller and recipient has an alternative recipient process that processes unanswered calls. A typical alternative recipient process waits for a predetermined waiting time for the recipient to answer an incoming call, and then forwards an unanswered incoming call to an alternative recipient such as a receptionist, an assistant, an alternative number, a voice mail service or another alternative recipient. The intermediate communication device continues to provide the incoming call indication while it waits for the recipient to answer the incoming call. When the recipient does not provide the courtesy hold user input within the predetermined waiting time, the alternative recipient process at the intermediate communication device takes over the incoming call and hangs up the connection to the personal voice communication device. This is typically done by discontinuing the incoming call indication that the personal voice communication device received in block 122.

In an embodiment, the predetermined waiting time of the alternative recipient process of the intermediate communication device is used to define the first waiting time. In such embodiment, the test performed in block 128 determines whether the first waiting time has expired by determining whether the incoming call indication received in block 122 is still being received. As noted above, when an incoming call is not answered within a predetermined time, the alternative recipient process performed at the intermediate communication device forwards the incoming call to an alternative recipient, and additionally discontinues the incoming call indication. The consequent absence of the incoming call indication causes a YES result (incoming call indication discontinued) in block 128, which prevents the courtesy hold process from being performed.

In an embodiment of method 120 performed by the personal voice communication device in which the personal voice communication device is set to respond to incoming calls using the courtesy hold process, the personal voice communication device sends to the intermediate communication device a signal that indicates that the personal voice communication device is capable of answering the incoming call using a courtesy hold process. Receipt of such signal may modify the way in which the intermediate communication device handles the incoming call. In an example, such signal causes the intermediate communication device to extend the waiting time of its alternative recipient process to give the recipient additional time in which to provide the courtesy hold user input in block 126. In an embodiment of method 120 performed by the intermediate communication device in which the intermediate communication device is set to respond to incoming calls using the courtesy hold process, the intermediate communication device autonomously modifies the way in which it handles incoming calls by, for example, extending the above-mentioned waiting time.

In another embodiment of method 120 performed by the personal voice communication device, the alternative recipient process is performed by the personal voice communication device. In this, the personal voice communication device forwards the incoming call to an alternative recipient in the event the recipient fails to provide the courtesy hold user input within a waiting time local to the personal voice communication device. The local waiting time is less than the waiting time of the alternative recipient process at the intermediate communication device. In this embodiment, the test performed in block 128 tests whether the local waiting time has elapsed. A NO result causes execution to return to block 126 as described above. A YES result causes execution to advance to block 140, where the personal voice communication device forwards the incoming call to the alternative recipient, as will be described in more detail below. Such embodiment may additionally provide a signal to the intermediate communication device to cause intermediate communication device to extend the waiting time of its alternative recipient process, as described above.

As noted above, a YES result in block 126 causes execution to advance to block 130. In block 130, the courtesy hold process is performed. In this example, the courtesy hold process is composed of blocks 110-116 and 132-140. In block 110, the incoming call is answered, establishing communication with the caller. In some embodiments, the impedance of a communication line is changed to answer the incoming call. More commonly, the personal voice communication device sends to the intermediate communication device a digital answer signal whose state indicates whether the incoming call has been answered. In response to the answer signal, the intermediate communication device discontinues the incoming call indication. The intermediate communication device answers the incoming call by changing the impedance on a line or, more typically, by sending an answer signal to the caller.

In block 114, a courtesy hold message is sent to the caller. In the example shown, the courtesy hold message is a verbal message and is preceded with an audible cue sent in optional block 112. The audible cue is sent to distinguish the courtesy hold message from a conventional voice mail outgoing message. One purpose of the audible cue is to reduce the likelihood of the caller hanging up thinking that the incoming call has been forwarded to voice mail.

The courtesy hold message sent in block 114 advises the caller that the recipient is temporarily unavailable to take the call, but will be available shortly, and asks the caller to hold on. In an example in which a verbal message constitutes at least part of the courtesy hold message, the verbal message is worded as follows: “Hello, I'm in a meeting right now and can't talk to you right away, but if you give me 30 seconds, I will find a place where I can talk with you. Please don't hang up . . . .” The verbal message can be worded differently from this example, or the courtesy hold message can be a non-verbal message, as mentioned above.

In block 116, the incoming call is temporarily put on hold, and execution advances to block 132. Putting the incoming call temporarily on hold maintains communication with the caller. In embodiments performed by the personal voice communication device, putting the incoming call temporarily on hold typically additionally mutes at least the microphone of the personal voice communication device. In some embodiments, the loudspeaker of the personal voice communication device is additionally muted while the incoming call is on hold. In some embodiments, music is played to the caller while the incoming call is on hold. The music may additionally be played to the recipient to remind the recipient that the incoming call is on hold.

In an embodiment performed in part by the personal voice communication device and in part by the intermediate communication device, the personal voice communication device puts the incoming call on hold by sending a hold signal to the intermediate communication device. In response to the hold signal, the intermediate communication device puts the incoming call on hold, typically with music. While on hold this way, voice communication exists between the caller and the intermediate communication device, but only system signal communication exists between the recipient and the intermediate communication device.

In block 132, a test is performed to determine whether a pick-up user input has been received. A NO result causes execution to advance to block 134, described next. A YES result causes execution to advance to block 136. In block 136, performed when a pick-up user input has been received, the incoming call is taken off hold, which puts the parties in voice communication with one another. In an embodiment, taking the incoming call off hold simply un-mutes the microphone and, if muted, the speaker of the personal voice communication device, and discontinues playing music if music was playing. In another embodiment, taking the incoming call off hold involves the personal voice communication device discontinuing sending the hold signal to the intermediate communication device. This causes the intermediate communication device to re-establish voice communication with the personal voice communication device and, hence, to establish voice communication between the caller and the recipient. After completion of block 136, execution exits courtesy hold process 130.

After exiting courtesy hold process 130, execution advances to block 142, where a test is performed to determine whether either of the parties has hung up. A NO result causes execution to return to block 142, typically via a delay (not shown). A YES result causes execution to return to block 122 to await the next incoming call indication.

As noted above, a NO result in block 132 (no pick-up user input received) causes execution to advance to block 134. In block 134, a test is performed to determine whether a second predetermined waiting time has elapsed. The second waiting time defines the maximum time allowed for the recipient to provide the pick-up user input. A NO result causes execution to return to block 132, typically via a delay (not shown). A YES result causes execution to advance to block 138.

In block 138, an additional courtesy hold message is sent to the caller. Block 138 is performed when the recipient fails to provide the pick-up user input within a predetermined waiting time. The additional courtesy hold message informs the caller that the recipient will not be answering the incoming call after all. Typically, the additional courtesy hold message is a verbal message in which the recipient apologizes to the caller for the recipient's failure to pick up the incoming call and advises the caller that the incoming call is being forwarded to an alternative recipient, e.g., a receptionist, an assistant, an alternative number, a voice mail service or another alternative recipient. In an embodiment, the verbal message that constitutes at least part of the additional courtesy hold message is worded as follows: “I'm sorry, I seem to be unable to exit my meeting. Please leave me a voice mail and I will retrieve it as quickly as possible. Cheers!” The verbal message may be preceded in the additional courtesy hold message by an additional audible cue in a manner similar to that described above with reference to the courtesy hold message. The additional audible cue may eventually constitute the entire additional courtesy hold message in a manner similar to that described above with reference to the courtesy hold message. Execution then advances to block 140.

In block 140, the incoming call is forwarded to the alternative recipient. In an embodiment performed by the personal voice communication device, the personal voice communication device has a call forwarding process that is activated in block 140. The personal voice communication device sends signals that instruct an intermediate communication device such as a central office, to take over the incoming call and to forward the incoming call to a recipient whose number is pre-programmed at the intermediate communication device, e.g., a voice mail service, or is provided to the intermediate communication device as part of the call forwarding instructions. In an embodiment performed by the intermediate communication device, the alternative recipient function of the intermediate communication device takes over the incoming call and forwards it to the alternative recipient. Execution then exits courtesy hold process 130 and returns to block 122 to await the next incoming call indication.

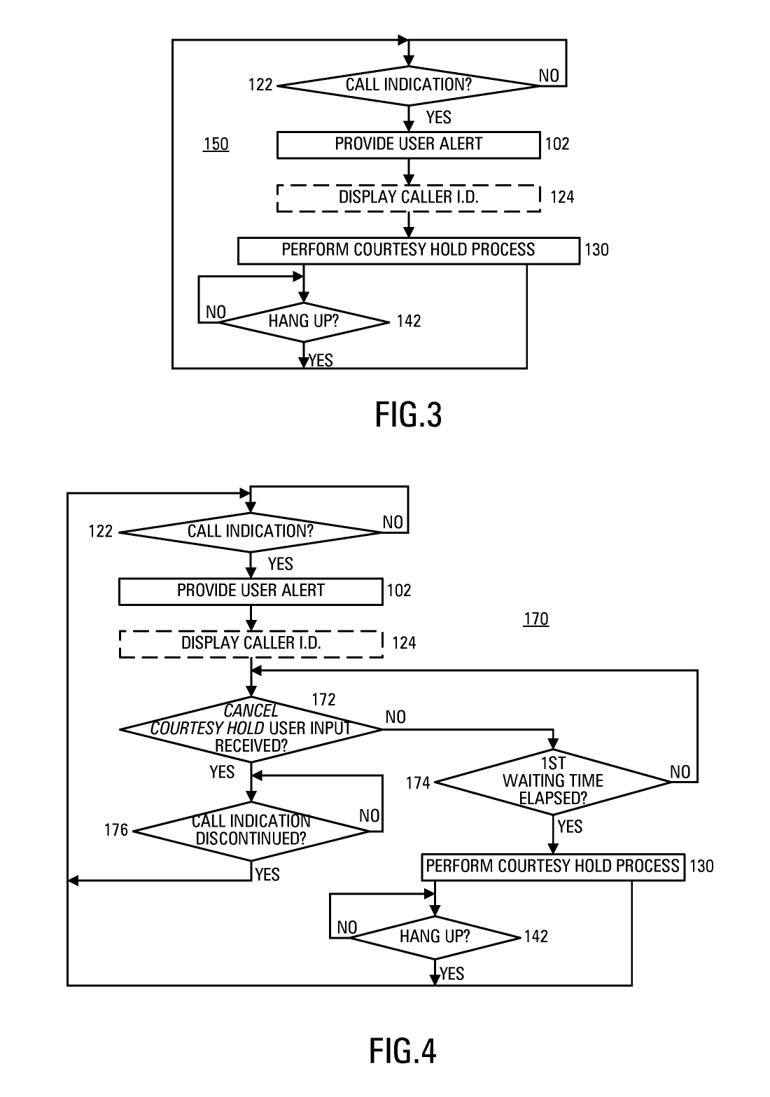

FIG. 3 is a flow chart showing an example of a method 150 in accordance with an embodiment of the invention in which the courtesy hold process is performed automatically in response to each incoming call. Method 150 is similar to method 120 described above with reference to FIG. 2 except that the courtesy hold user input process performed in blocks 126 and 128 is omitted. Instead, execution advances directly to courtesy hold block 130 from optional block 124.

In one embodiment, the recipient provides a user input (not shown) to the personal voice communication device before entering a telephone conversation-inappropriate location or while at such location. The user input sets the personal voice communication device or the intermediate communication device to perform method 150 in which the courtesy hold process is performed automatically. Once the personal voice communication device or the intermediate communication device has been set to perform method 150 shown in FIG. 3, the personal voice communication device or the intermediate communication device performs the courtesy hold process automatically in response to each incoming call.

The recipient can later provide a user input (not shown) to the personal voice communication device to set the personal voice communication device or the intermediate communication device to perform method 120 described above with reference to FIG. 2 in which the courtesy hold process is performed in response to a courtesy hold user input. Alternatively, once in a location in which a telephone conversation would be appropriate, the recipient can provide a user input (not shown) to the personal voice communication device that sets the personal voice communication device or the intermediate communication device so that it does not perform the courtesy hold process at all. The personal voice communication device has soft keys or, more conveniently, hard keys or switches to receive the above-described user inputs.

In an embodiment of method 150 intended for applications in which courtesy is of paramount importance, the personal voice communication device is preset at the factory to start up in the automatic performance mode. This causes the personal voice communication device to revert to the automatic performance mode on power-on regardless of the performance mode to which the personal voice communication device was previously set. The personal voice communication device can additionally be programmed, even if set to another performance mode, to revert to the automatic performance mode after a predetermined time or after receiving a predetermined number of incoming calls. An intermediate communication device that performs the call responding method can also be programmed to make the automatic performance mode its default performance mode and, even if set to another performance mode, to revert to the automatic performance mode after a predetermined time or after receiving a predetermined number of incoming calls.

In another embodiment, setting the personal voice communication device or the intermediate communication device to perform method 150, in which the courtesy hold process is performed automatically, additionally automatically sets the user alert of the personal voice communication device to its silent mode.

FIG. 4 is a flow chart showing an example of a method 170 in accordance with an embodiment of the invention in which the courtesy hold process is performed automatically but can be cancelled by a cancel courtesy hold user input. Method 170 is similar to method 150 described above with reference to FIG. 3, but includes additional blocks 172, 174 and 176 between block 124 and block 130.

Block 172 is performed after or concurrently with block 102 and optional block 124. In block 172, a test is performed to determine whether a cancel courtesy hold user input has been received. A NO result causes execution to advance to block 174, described next. A YES result causes execution to advance to block 176, described below. The recipient provides a cancel courtesy hold user input when the caller identification provided in block 124 or a distinctive caller-specific or caller group-specific user alert provided in block 102 indicates that the incoming call is from a caller that the recipient does not need to talk to immediately. If the recipient does not provide the cancel courtesy hold user input within a predetermined additional waiting time, the personal voice communication device or the intermediate communication device performs the courtesy hold process automatically.

In block 174, a test is performed to determine whether a first waiting time has elapsed. The first waiting time defines the maximum time allowed for the user to provide the cancel courtesy hold user input. In this embodiment, the first waiting time is less than the above-described predetermined waiting time of the alternative recipient process of the intermediate communication device to prevent the alternative recipient process of the intermediate communication device from preempting courtesy hold process 130. A NO result causes execution to return to block 172, typically after a delay (not shown). A YES result causes execution to advance to block 130, where the courtesy hold process is performed as described above.

An embodiment of incoming call answering method 170 performed by the personal voice communication device causes the personal voice communication device to send to the intermediate communication device a signal that indicates that it has activated a courtesy hold process to answer the incoming call. Receipt of such signal modifies the way in which the intermediate communication device handles the incoming call. In an example, such signal causes the intermediate communication device to extend the waiting time of its alternative recipient process to give the recipient additional time in which to provide the cancel courtesy hold input in block 174. In an embodiment of method 170 performed by the intermediate communication device, the intermediate communication device autonomously modifies the way in which it handles incoming calls by, for example, extending the waiting time of its alternative recipient process to allow a longer first waiting time.

Block 176 is performed after a YES result is obtained in block 172. In block 176, a test is performed to determine whether the call indication received in block 122 has been discontinued. A YES result causes execution to return to block 122 to await the next incoming call indication. A NO result causes execution to return to block 176 after a delay (not shown). A NO result indicates that the alternative recipient process of the intermediate communication device is still waiting for the incoming call to be picked up. A YES result indicates that a time greater than the above-described waiting time of the alternative recipient process of the intermediate communication device has elapsed and that the alternative recipient process of the intermediate communication device has forwarded the incoming call to the designated alternative recipient, typically a voice mail service. The YES result additionally indicates that the alternative recipient process of the intermediate communication device has hung up on the incoming call, resulting in a discontinuation of the incoming call indication. With the incoming call indication discontinued, a YES result is obtained in block 176, and execution then returns to block 122 to await the next incoming call indication.

In a variation on the method embodiments described above with reference to FIGS. 2, 3 and 4, a pick-up user input received at any point in the method prior to block 132 aborts the call responding method and picks up the incoming call. This facility is useful in instances when the recipient has activated the courtesy hold process but is no longer in a telephone conversation-inappropriate location and wants to speak to the caller without incurring the risk of the caller hanging up during the courtesy hold process.

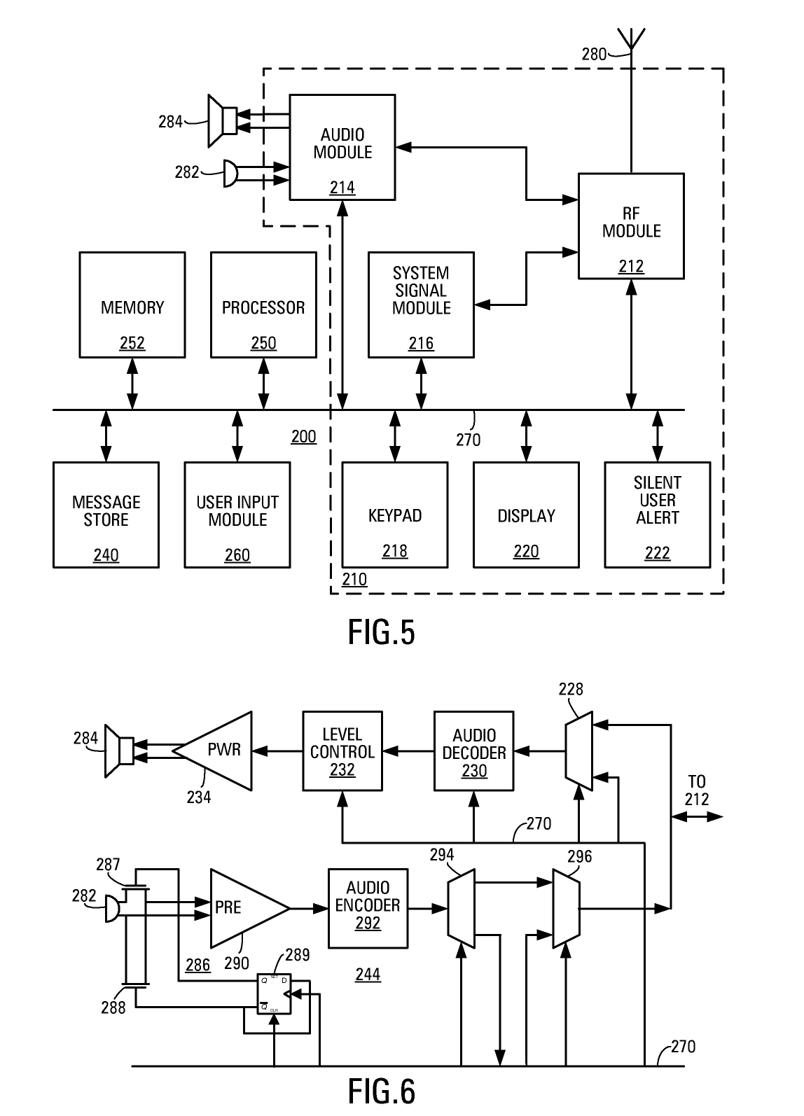

FIG. 5 is a block diagram showing an example of a personal voice communication device 200 in accordance with an embodiment of the invention. Personal voice communication device 200 performs a method in accordance with an embodiment and is capable of responding to an incoming call by providing a user alert and performing a courtesy hold process in which it answers the incoming call, sends a courtesy hold message as a response to the incoming call and temporarily puts the incoming call on hold. This gives the recipient time to move from a telephone conversation-inappropriate location to a location where a telephone conversation would be appropriate to take the incoming call.

The example of personal voice communication device 200 shown is composed of a communication system 210, a message store 240, a processor 250, memory 252 associated with processor 250, and a user input module 260. A bus 270 is electrically coupled to, and communicates digital signals among, communication system 210, message store 240, processor 250, memory 252 and user input module 260.

The example of communication system 210 shown is composed of a radio frequency (RF) module 212, an audio module 214, a system signal module 216, a keypad 218, a display 220 and a silent user alert 222. Bus 270 is additionally electrically coupled to, and additionally communicates digital signals among, RF module 212, audio module 214, system signal module 216, keypad 218, display 220 and silent user alert 222 within communication system 210.

The example of personal voice communication device shown is additionally composed of an antenna 280 electrically coupled to RF module 212, and a microphone 282 and an earphone 284 electrically coupled to audio module 214.

In personal voice communication device 200, processor 250 is a typically a microprocessor, a microcontroller or another suitable processing device that operates in response to a program stored in memory 252 to control the various functions of the personal voice communication device. Processor 250 controls the communication of digital signals among the modules constituting personal voice communication device 200.

Memory 252 has two or more sections of different volatility: a read-only section, a random access section and, typically, a programmable section. The read-only section stores the program that controls processor 250. The programmable section stores data representing various system parameters. The random-access section stores data operated on by processor 250. In some embodiments, the programmable section is implemented using flash memory or another type of programmable read-only memory to allow updating. In embodiments of personal voice communication device 200 in which the courtesy hold process has more than one operational mode, data indicating the currently-selected operational mode is stored in the programmable portion of memory 252. Memory 252 may constitute part of processor 250.

Message store 240 is a memory that stores digital data representing one or more courtesy hold messages. In an embodiment in which the courtesy hold messages are factory-defined, message store 240 is implemented using read-only memory. In an embodiment in which the courtesy hold messages can be user-defined, message store 240 is implemented using an erasable and programmable read-only memory, such as flash memory. Some embodiments are supplied with factory-defined courtesy hold messages stored in message store 240 but allow the user to replace or supplement the factory-defined courtesy hold messages stored in message store 240 with courtesy hold messages of the user's own. Memory store 240 may constitute part of memory 252 that may in turn constitute part of processor 250, as described above.

User input module 260 comprises one or more controls by means of which the user controls the operation of the courtesy hold feature of personal voice communication device 200. User input module generates respective system signals in response to the various user inputs, e.g., a pick-up signal in response to a pick-up user input. The user input module may additionally comprise controls by means of which the user control the operation of other features of personal voice communication device 200, but such controls will not be described here.

In an embodiment of personal voice communication device 200 in which the courtesy hold process can only be performed automatically, user input module 260 provides only a single control for the recipient to provide the pick-up user input.

In an embodiment of personal voice communication device 200 in which the courtesy hold process is performed in response to a user input, user input module 260 has a control that provides the courtesy hold user input and a control for the recipient to provide the pick-up user input. Alternatively, user input module 216 has a single control that can be operated a first time to provide the courtesy hold user input and that can be operated a second time to provide the pick-up user input. As another alternative, user input module 260 has a single control that can be operated in two different ways to provide the courtesy hold user input and the pick-up user input. In an embodiment of personal voice communication device 200 having a clamshell configuration, the control that provides the courtesy hold user input is advantageously a hard key located on an outer surface of the personal voice communication device to maximize the convenience with which the recipient can provide the courtesy hold user input.

In an embodiment of personal voice communication device 200 in which the recipient can select whether the courtesy hold process is performed automatically or in response to a user input, user input module 260 additionally has an operational mode user input by means of which the recipient can select the operational mode of the courtesy hold process. To save having to provide additional hard keys on the already crowded surface of a personal voice communication device, the operational mode user input can be provided by soft key, i.e., by adding an operational mode selection menu to the personal voice communication device's operational menus. The recipient then selects the operational mode by manipulating existing menu selection keys to display the operational mode selection menu and to select the desired operational mode from the operational mode selection menu. Implementing the controls that provide the pick-up user input and the courtesy hold user input as hard keys maximizes convenience, however, as the recipient has to provide these user inputs within a predetermined time.

An existing control can be used to provide the pick-up user input. In one example, the existing control is part of keypad 216, such as a conventional call answering control. In another example, the existing control is the act of opening a personal voice communication device having a clamshell configuration.

In an embodiment, at least part of user input module 260 constitutes part of keypad 218, described below.

In communication system 210, RF module 212 comprises a transmitter (not shown) and a receiver (not shown) electrically coupled to antenna 280 and to audio module 214 and to system signal module 216. The transmitter receives a digital audio signal from audio module 214 and a multiplexed digital system signal from system signal module 216, separably combines these signals, modulates an RF carrier with the combined signal and feeds the modulated RF signal to antenna 280. The digital audio signal and the multiplexed digital system signal may be combined after the modulation. The receiver receives an RF signal from antenna 280, amplifies the RF signal, separates a wanted modulated RF signal from the amplified RF signal, demodulates the wanted RF signal to generate a baseband signal, separates the baseband signal into a digital audio signal and a multiplexed digital system signal, provides the digital audio signal to audio module 214 and provides the multiplexed digital system signal to system signal module 216. The digital audio signal and the multiplexed digital system signal may alternatively be separated before the demodulation.

Audio module 214 converts an electrical microphone signal received from microphone 282 to a digital audio signal. Audio module 214 additionally receives a digital audio signal representing at least one courtesy hold message from message store 240 via bus 270. In response to a control signal received from processor 250 via bus 270, audio module 214 selects the digital audio signal representing the above-described microphone signal or the digital signal representing the courtesy hold message for output to RF module 212.

Optionally, audio module 214 additionally outputs the digital audio signal representing the microphone signal to processor 250 via bus 270. The program executed by processor 250 includes a courtesy hold message recording routine that allows the user of personal voice communication device 200 to record his/her own courtesy hold messages. When executed, the courtesy hold message recording routine causes processor 250 to store the digital audio signal on bus 270 in message store 240.

Audio module 214 is additionally capable of muting microphone 282. In one embodiment, this is done in the analog domain by, for example, placing a low-impedance connection across the electrical output of the microphone in response to a control signal received from processor 250. In another embodiment, this is done in the digital domain by generating the digital audio signal representing the microphone signal in a state that represents no microphone signal. This can be done by audio module 214 synthesizing such a digital audio signal, or by audio module 214 receiving a digital audio signal that represents no microphone signal from message store 240. Other ways of muting a microphone are known in the art and may alternatively be used.

Audio module 214 additionally receives a digital audio signal from the receiver (not shown) of RF module 212, converts the digital audio signal into an analog audio signal and drives earphone 284 with the analog audio signal. Additionally, audio module 214 controls the level of the analog audio signal driving earphone 284 in response to a level control signal received from processor 250 via bus 270. More typically, audio module 214 controls the level of the analog audio signal indirectly by processing the digital audio signal. Processor 250 generates such level control signal in response to a user input provided at keypad 218 for example.

Audio module 214 is additionally capable of receiving from bus 270 a digital audio signal representing a ring tone. Processor 250 operates in response to receiving an incoming call indicator from system signal module 216 to read a set of data representing the ring tone from memory 252 and to provide the resulting digital audio signal to audio module 214 via bus 270. Processor 250 additionally provides a level control signal to audio module 214 to set the audio signal level to a user-defined ringer level. Audio module 214 additionally converts the digital audio signal to an analog ring tone signal that earphone 284 converts to an audible user alert.

System signal module 216 receives various system signals from processor 250 via bus 270, multiplexes them and provides a multiplexed system signal to RF module 212 for transmission to the base station with which personal voice communication device communicates wirelessly. Examples of the system signals an answer signal, a hold signal, a call forward signal, and respective signals representing the numerals 0 through 9, the characters * and #, and navigation and selection instructions entered via keypad 218 or read by processor 250 from memory 252. Most of the system signals are generated by processor 250 in response to the user operating keypad 218 or other controls.

The base station additionally transmits system signals to personal voice communication device 200. The RF signal received at RF module 212 from antenna 280 represents signals including such system signals. System signal module 216 receives the multiplexed system signal from RF module 212, demultiplexes the multiplexed system signal and provides the resulting individual system signals to processor 250. Examples of the system signals received from the base station include the above-mentioned incoming call indication, caller identification information, voice mail waiting signal, missed call information, etc.

Keypad 218 has keys for entering the numerals 0 through 9 and the characters * and #, and may comprise additional keys for entering the letters A-Z and various punctuation and other characters. Additionally, the keypad has navigation keys for providing navigation instructions to display 220, a select key and various function select keys. Keypad 218 generates a digital code corresponding to each key pressed and outputs the code to bus 270.

In some embodiments, user input module 260 is omitted and the recipient provides the user inputs described herein by inputting a sequence of keystrokes using keypad 218. Alternatively, only one or some of the user inputs are provided by inputting a sequence of keystrokes on keypad 218 and the remaining user inputs are provided using user input module 260. This enables a simpler user input module to be used. Typical sequences of keystrokes that represent respective user inputs begin with the * character or the # character to distinguish them from telephone numbers.

Display 220 is a color or monochrome display that provides information to the user and, together with keypad 218, constitutes part of the system used by the user to control the operation of personal voice communication device 200. Of particular relevance to the courtesy hold function of personal voice communication device 200, display 220 displays caller identification information when an incoming call is received.

Silent user alert 222 comprises a vibrator or another device capable of silently alerting the recipient to an incoming call. Silent user alert 222 operates in response to an activation signal generated by processor 250 in response to receiving an incoming call indication and provided to silent user alert 222 via bus 270. Additionally, alternatively or sequentially, audio module 214 and earphone 284 collectively provide an audible user alert in response to a digital audio signal representing a ring tone.

FIG. 6 is a block diagram showing an example of an audio module 244 that may be used as audio module 214 in the example of personal voice communication device 200 described above with reference to FIG. 5. Audio module 214 is composed of an audio decoder 230, a level controller 232, a power amplifier 234, a mute circuit 286, a pre-amplifier 290, an audio encoder 292, and multiplexers 228, 294 and 296.

Multiplexer 228 has two signal inputs, a control input and a signal output. One signal input is connected to receive a digital audio signal representing an audio signal, typically a speech signal, from RF module 212. The other signal input is connected to bus 270 to receive from processor 250 a digital audio signal representing a ring tone. The signal output is connected to the input of audio decoder module 230. The control input is connected to bus 270. The state of the control signal received at the control input of multiplexer 228 determines whether multiplexer 228 feeds the digital audio signal output by RF module 212 and representing an audio signal, or the digital audio signal received from bus 270 and representing a ring tone, to the input of audio decoder module 230. Processor 250 provides the digital audio signal received from bus 270 and representing the ring tone by reading such signal from memory 252 in response to a ring tone selection made by the user using keypad 218 and display 220.

Audio decoder 230 has an input connected to the signal output of multiplexer 228, as described above, and an output connected to the input of level control 232. Audio decoder 230 converts the digital audio signal selected by multiplexer 228 to an analog audio signal and outputs the analog audio signal to level controller 232.

In the example shown, level controller 232 is connected to receive the analog audio signal output by audio decoder 230 and additionally to receive a level control signal from bus 270. Level controller 232 controls the level of the analog audio signal in response to the level control signal and outputs a resulting level-controlled analog audio signal to power amplifier 234. Processor 250 provides the level control signal received by level controller 232 in response to voice call volume and ringer volume selections made by the user typically using keypad 218 and display 220. The level defined by the level control signal typically depends on which digital audio signal is selected by multiplexer 228.

Alternatively, instead of level controller 232 operating on the analog audio signal output by audio decoder 230, level controller 232 processes the digital audio signal output by multiplexer 228, i.e., the digital audio signal received from RF module 212 or the digital audio signal received from bus 270, to control the level of the analog audio signal indirectly. In yet another alternative, level controller 232 processes a higher bit-rate digital audio signal obtained by partially decoding the digital audio signal received from multiplexer 228 to control the level of the analog audio signal indirectly. In these examples, level controller 232 precedes audio decoder module 230 or is embedded in audio decoder module 230, and the output of audio decoder 230 is connected directly to the input of power amplifier 234.

In the example shown, power amplifier 234 has an input connected to receive the level-controlled analog audio signal from level controller 232 or directly from audio decoder 230, as described above. Power amplifier 234 amplifies the analog audio signal to a level suitable for driving earphone 284.

Microphone 282 is connected to the input of preamplifier 290 via mute circuit 286, described below. Preamplifier 290 amplifies an analog microphone signal generated by microphone 282 in response to the user's speech.

Audio encoder 292 has an input connected to receive the amplified microphone signal from the output of preamplifier 290 and digitally encodes the amplified microphone signal to generate a digital audio signal.

Multiplexer 294 has a signal input, a control input and two signal outputs. The signal input is connected to receive the digital audio signal output by audio encoder 292. The control input and one of the signal outputs are connected to bus 270. The other signal output is connected to multiplexer 296, described below. The state of the control signal received at the control input of multiplexer 294 determines whether multiplexer 294 feeds the digital audio signal generated by audio encoder 292 to RF module 212 for transmission, or to message store 240 for storage as a courtesy hold message.

Multiplexer 296 has two signal inputs, a control input and a signal output. One signal input is connected the above-mentioned other signal output of multiplexer 294 to receive the digital audio signal output by audio encoder 292. The control input and the other of the signal inputs are connected to bus 270. The signal output is connected to RF module 212. The state of the control signal received at the control input of multiplexer 296 determines whether multiplexer 296 feeds the digital audio signal generated by audio encoder 292, or the digital audio signal representing a courtesy hold message, to RF module 212 for transmission to the caller. Multiplexer 296 receives the digital audio signal generated by audio encoder 292 via multiplexer 294.

In the example shown, mute circuit 286 is composed of a transistor 287 connected in series with microphone 282 and the input of preamplifier 290, a transistor 288 connected in parallel with the input of preamplifier 290, and a flip-flop 289. The gates of transistors 287 and 288 are connected to the Q and Q-bar outputs, respectively, of flip-flop 289. The Q-bar output of flip-flop 289 is additionally connected to the D-input of flip-flop 289. The clock and clear (CLR) inputs of flip-flop 289 are connected to respective conductors of bus 270.

On power on, processor 250 provides to the CLR input of flip-flop 289 via bus 270 a control signal that sets flip-flop 289 to a state in which transistor 287 connects microphone 282 to preamplifier 290, and transistor 288 is switched off. In this state, mute circuit 286 is deactivated. A control signal received at the clock input of flip-flop 289 from bus 270 activates mute circuit 286 by changing the state of flip-flop 289 so that transistor 287 is turned off, disconnecting microphone 282 from preamplifier 290, and transistor 288 is turned on, shorting the input of preamplifier 290. A subsequent control signal received at the clock input of flip-flop 289 from bus 270 restores mute circuit 286 to its deactivated state.

Mute circuit 286 may be omitted in embodiments of personal voice communication device 200 in which personal voice communication device 200 provides a hold signal to the intermediate communication device (not shown) via system signal module 216. The hold signal instructs the intermediate communication device to put the incoming call on hold.

In the examples of personal voice communication device 200 and audio module 214 described above with reference to FIGS. 5 and 6, bus 270 is used to exchange digital signals among the various circuit elements. Alternatively, direct and indirect connections may be provided to provide the necessary signal connections among the various circuit elements. Moreover, personal voice communication device 200 and audio module 214 can be implemented using circuits different from those described above.

Operation of an exemplary embodiment of personal voice communication device 200 to perform call responding method 120 described above with reference to FIG. 2 will now be described with reference to FIG. 2 and FIG. 5. In the example described below, personal voice communication device 200 is in the possession of a recipient and is in wireless communication with a base station (not shown). The base station, in turn, is in communication with a central office (not shown) that serves as an intermediate communication device. The recipient is initially situated in a telephone conversation-inappropriate location, but, before entering such location, has provided a user input to personal voice communication device 200 to cause the personal voice communication device to execute call responding method 120 in which the courtesy hold process is performed in response to a user input and additionally to cause personal voice communication device 200 to provide only a silent user alert.

In personal voice communication device 200, processor 250 executes a program that causes processor 250 to operate in a wait mode in which it waits for one of the following events to occur: the user provides a user input to initiate a call, for example; and system signal module 216 outputs an incoming call indication.

Personal voice communication device 200 receives an incoming call indication when the RF signal transmitted by the base station and received via antenna 280 and RF module 212 includes such incoming call indication. The incoming call indication indicates that the central office has received an incoming call destined for personal voice communication device 200. The RF signal typically additionally includes caller identification information. The system signal module 216 extracts the incoming call indication from the multiplexed control signal received from RF module 212 and outputs the incoming call identification and caller identification information, if received, to bus 270. To determine whether an incoming call has arrived, the program executed by processor 250 causes the processor to monitor the output of system signal module 216 via bus 270 (block 122).

In response to detecting the incoming call indication, processor 250 reads the user-selected alert mode from the programmable portion of memory 252 and sends an activation signal to the appropriate user alert (block 102). In this example, since the user has been considerate to others in the telephone conversation-inappropriate location and has selected silent mode only as the user alert mode, processor 250 provides the activation signal only to silent user alert 222. In response to the activation signal, silent user alert 222 notifies the recipient that an incoming call has arrived.

Processor 250 additionally stores the caller identification information output by system signal module 216 in the volatile portion of memory 252 and, from the caller identification information, generates display data that it provides to display 220. In response, display 220 displays the caller identification to the recipient (block 124).

Alerted by silent user alert 222 that an incoming call has been received, the recipient discreetly looks at display 220 to determine the identity of the caller. The recipient can then decide whether to have personal voice communication device perform the courtesy hold process. If the recipient decides to activate the courtesy hold process, the recipient provides the courtesy hold user input at user input 260, excuses him/herself from the telephone conversation-inappropriate location and makes for a location where a telephone conversation would be appropriate.

Meanwhile, processor 250 checks the output of user input module 260 via bus 270 to determine whether the user input module has generated a courtesy hold signal in response to receiving a courtesy hold user input (block 126). If the user input module has not generated a courtesy hold signal, processor 250 additionally checks to determine whether the first waiting time has expired by checking the output of system signal module 216 to determine whether the incoming call indication has been discontinued (block 128). A presence of the incoming call indication causes processor 250 to check the output of user input module 260 again to determine whether the user input module has received a courtesy hold user input. Discontinuation of the incoming call indication indicates to processor 250 that the caller has hung up or that the central office has performed its alternative recipient process. Discontinuation of the incoming call indication causes processor 250 to revert to its wait mode, described above, to await a user input or a new incoming call indication (block 222).

Once processor 250 detects that the recipient has provided a courtesy hold user input at user input module 260, processor 250 executes the courtesy hold process (block 130). In executing the courtesy hold process, processor 250 provides an answer signal to system signal module 216. System signal module 216 multiplexes the answer signal with any other system signals that require transmission to generate the multiplexed system signal and provides the multiplexed system signal to RF module 212. RF module 212 transmits the multiplexed system signal including the answer signal to the central office, effectively answering the incoming call (block 110). In response to the answer signal, the central office discontinues sending the incoming call indication and additionally transmits a digital audio signal to personal voice communication device 200. This establishes voice communication between personal voice communication device 200 and the central office.

After answering the incoming call, processor 250 reads a set of data representing the courtesy hold message from message store 240, feeds the resulting digital audio signal representing the courtesy hold message to multiplexer 296 via bus 270, and feeds a control signal to multiplexer 296 to cause multiplexer 296 to feed the digital audio signal to RF module 212. RF module 212 transmits the digital audio signal representing the courtesy hold message to the caller via the central office (block 114). As noted above, the signals transmitted by personal voice communication device 200 are transmitted wirelessly to a nearby base station and thence wirelessly or by other means to the central office and the caller. The final link to the caller may additionally be a wireless link.

Optionally, the courtesy hold message read from message store 240 begins with an audible cue (block 112). Alternatively, processor 250 reads a set of data representing an audible cue from message store 240 and feeds the resulting digital audio signal representing the audible cue to multiplexer 296 (block 112) prior to reading the set of data representing the verbal message that constitutes the remainder of the courtesy hold message from message store 240 (block 114). This allows processor 250 to precede all verbal messages with the same audible cue.

Processor 250 then puts the incoming call on hold by maintaining the answer signal and muting microphone 282. Maintaining the answer signal maintains communication between personal voice communication device 200 and the caller via the central office. In the example of audio module 214 described above with reference to FIG. 6, processor 250 sends a control signal to activate mute circuit 286 via bus 270 (block 116).

Optionally, processor 250 additionally reads a non-volatile portion of memory 252 in which sets of data representing on-hold music are stored, and feeds the resulting digital audio signal representing on-hold music to multiplexer 296 via bus 270. Processor 250 additionally feeds a control signal to multiplexer 296 to cause multiplexer 296 to feed the digital audio signal representing the on-hold music to RF module 212. RF module 212 transmits the digital audio signal representing the on-hold music to the caller via the central office.

In another embodiment in which the central office is capable of putting the incoming call on hold in response to a hold signal, processor 250 provides a hold signal to system signal module 216. System signal module 216 multiplexes the hold signal with the answer signal and any other system signals that require transmission to generate the multiplexed system signal and provides the multiplexed system signal to RF module 212. RF module 212 transmits the multiplexed system signal including the hold signal to the central office. In response to the hold signal, the central office puts the incoming call on hold until such time as it no longer receives the hold signal from personal voice communication device 200 (block 116). The central office may provide music while it has the incoming call on hold.

Once the recipient has reached a location where a telephone conversation would be appropriate, the recipient provides a pick-up user input at user input module 260. As noted above, the conventional call answering key or opening a personal voice communication device having a clamshell configuration may provide the portion of the user input module that receives the pick-up user input.

After it has put the incoming call on hold, processor 250 checks the output of user input module 260 via bus 270 to determine whether the user input module has generated a pick-up signal in response to receiving a pick-up user input (block 132). Alternatively, processor 250 may begin checking for whether the user input module has received the pick-up user input as soon as it has received the courtesy hold user input. Processor 250 additionally performs a count-down timer routine that defines the second waiting time. Personal voice communication device 200 may be pre-programmed with the second waiting time or may provide the user with the ability to select the second waiting time. In either alternative, the second waiting time is typically stored in the programmable portion of memory 252. If user input module 260 has not received a pick-up user input, processor 250 additionally checks the countdown timer routine to determine whether the second waiting time has elapsed (block 134). If the second waiting time has not elapsed, processor 250 to checks the output of user input module 260 again, typically after a delay, to determine whether the pick-up user input has been received.

User input module 260 receiving the pick-up user input causes processor 250 to discontinue the hold signal. Discontinuing the hold signal causes mute circuit 286 to un-mute microphone 282, which establishes communication between the caller and the recipient. Alternatively, discontinuing the hold signal causes the central office to take the incoming call off hold, which also establishes communication between the caller and the recipient (block 136).

Once the parties are in communication with one another, processor 250 checks whether the recipient has operated the end call control on keypad 218. In response to recipient operating the end call control, processor 250 discontinues the answer signal (block 142), which causes the central office to hang up the call and returns to its wait state (block 122). Otherwise, after a delay, processor 250 again checks whether the recipient has operated the end call control.

The second waiting time elapsing without the pick-up user input being received at user input module 260 indicates that the recipient has failed to reach a location where a telephone conversation would be appropriate, or has otherwise decided not to take the incoming call. Processor 250 then reads a set of data representing an additional courtesy hold message from message store 240, feeds the resulting digital audio signal representing the additional courtesy hold message to multiplexer 296 via bus 270, and feeds a control signal to multiplexer 296. The control signal causes multiplexer 296 to feed the digital audio signal to RF module 212. RF module 212 transmits the digital audio signal representing the additional courtesy hold message to the caller via the central office (block 138).

At the end of the additional courtesy hold message, processor 250 performs a local alternative recipient routine in which it sends call forwarding instructions to the central office via system signal module 216 and RF module 212. The call forwarding instructions cause the central office to forward the incoming call to an alternative recipient, for example, a voice mail service (block 140). After completion of the alternative recipient routine, processor 250 discontinues the answer signal, which causes the central office to hang up the incoming call. Processor 250 then returns to its wait mode (block 122).

Processor 250 may additionally or alternatively be programmed to perform the call responding methods described above with respect with reference to FIG. 3 and FIG. 4.

The functions described above as being performed by a central office may alternatively be performed by another intermediate communication device, such as the base station of a cordless telephone, capable of sending system signals to, and of responding to system signals received from, personal voice communication device 200.

The example of personal voice communication device 200 described above with reference to FIG. 5 is merely an example. The call responding methods described herein may be performed by personal voice communication device configurations different from that exemplified above. For example, analog signals may be substituted for corresponding digital signals.

FIG. 7 is a block diagram showing an example of an intermediate communication device in accordance with an embodiment of the invention. Intermediate communication device performs a method in accordance with an embodiment of the invention and is capable of responding to an incoming call destined for a personal voice communication device by providing a user alert and performing a courtesy hold process in which it answers the incoming call, sends a courtesy hold message as a response to the incoming call and temporarily puts the incoming call on hold. This gives the recipient time to move from a telephone conversation-inappropriate location to a location where a telephone conversation would be appropriate to take over the incoming call from the intermediate communication device.

In the example shown in FIG. 7, the intermediate communication device is embodied as a central office 300. The example of central office 300 shown is composed of multiple subscriber channels, an exemplary one of which is shown at 302, one or more trunk channels (not shown), a switch 304, a message store 340, a processor 350, memory 352 associated with processor 350 and a bus 370 that interconnects processor 350, memory 352, switch 304, the subscriber channels and the trunk channels. Each of the subscriber channels includes a subscriber link that connects a respective subscriber voice communication device, such as a telephone or a personal voice communication device, to switch 304. In the example shown, subscriber channel 302 includes a subscriber link 380 that connects a personal voice communication device 202 to switch 304. Subscriber link 380 includes a wireless link (not separately shown) that extends to personal voice communication device 202. Each trunk channel is connected to one of the trunk channels of another central office (not shown). The trunk channels will not be further described.

Switch 304 operates in response to processor 350 to connect an incoming call received via one of the subscriber channels or one of the trunk channels to another of the subscriber channels or to another of the trunk channels. Processor 350 is responsive to a telephone number that constitutes part of the incoming call to determine the channel to which switch 304 connects the subscriber channel carrying the incoming call.

Subscriber channel 302 additionally comprises a communication system 310 electrically connected to bus 370. The example of communication system 310 shown is composed of a multiplexer 312, an audio module 314 and a system signal module 316. Audio module 314 and system signal module 316 are electrically coupled to bus 370. The remaining subscriber channels are similarly structured.

Processor 350 is a typically a microprocessor, a microcontroller or another suitable processing device that operates in response to a program stored in memory 352 to provide various functions of the central office. Memory 352 comprises sections of different volatility; for example, a read-only section, a random access section and, typically, a programmable section. The read-only section stores the program that controls processor 350. The programmable section stores data representing various system parameters. The random-access section stores data operated on by processor 350. In some embodiments, the programmable section is implemented using flash memory or another type of programmable read-only memory to allow updating. In embodiments of central office 300 in which the courtesy hold process performed by each subscriber channel has more than one operational mode, data indicating the currently-selected operational mode of each subscriber channel is stored in the programmable portion of memory 352. Memory 352 may constitute part of processor 350.

Message store 340 is a memory that stores digital data representing one or more courtesy hold messages. In an embodiment of central office 300 in which the courtesy hold messages are factory-defined, message store 340 is implemented using read-only memory. In an embodiment in which the courtesy hold messages can be user-defined, message store 340 is implemented using an erasable and programmable read-only memory, such as flash memory, and is typically segmented to provide, for each subscriber channel, a message store segment in which the user-defined courtesy hold messages for the subscriber channel are stored. Some embodiments of central office 300 are supplied with factory-defined courtesy hold messages stored in message store 340 but allow the user to replace or supplement the factory-defined courtesy hold messages stored in message store 340 with courtesy hold messages of the user's own. Message store 340 may constitute part of memory 352 that may in turn constitute part of processor 350, as described above. Alternatively, message store 340 may constitute part of each subscriber channel 302.

In communication system 310, multiplexer 312 has ports electrically connected to audio module 314 and system signal module 316 and a common port electrically connected to subscriber link 380. Multiplexer 312 receives at its ports a digital audio signal from audio module 314 and a multiplexed digital system signal from system signal module 316, separably combines these signals, and feeds the resulting communication signal from its common port to personal voice communication device 202 and to switch 304 via subscriber link 380. Switch 304 selectively feeds the communication signal to another subscriber module or one of the trunk modules (not shown), as described above. Multiplexer 312 additionally receives a communication signal from subscriber link 380 at its common port and separates the communication signal into a digital audio signal and a multiplexed digital system signal that it outputs from its ports to audio module 314 and system signal module 316, respectively.

Audio module 314 receives from bus 370 a digital audio signal read from message store 340 and representing a courtesy hold message and feeds the digital audio signal to multiplexer 312.

In some embodiments of central office 300, the program executed by processor 350 includes a courtesy hold message recording routine that allows the user of a personal voice communication device connected to a subscriber channel of the central office to record his/her own courtesy hold messages. In such embodiments, audio module 314 is additionally capable of receiving a digital audio signal representing a courtesy hold message from multiplexer 312 and outputs such digital audio signal to bus 370. When the user records a courtesy hold message, subscriber channel 302 receives the digital audio signal representing the courtesy hold message from personal voice communication device 202 via subscriber link 380. The digital audio signal passes via multiplexer 312 and audio module 314 to bus 370. The courtesy hold message recording routine causes processor 350 to store the digital audio signal on bus 370 in message store 340.

System signal module 316 receives system signals from processor 350 via bus 370, multiplexes the system signals and provides the resulting multiplexed system signal to multiplexer 312 for multiplexer 312 to impose on subscriber link 380. Additionally, system signal module 316 receives a multiplexed system signal from multiplexer 312, demultiplexes the multiplexed system signal to recover the individual system signals and outputs the system signals to bus 370. Examples of the system signals include an answer signal, a hold signal, a call forward signal, and respective signals representing the numerals 0 through 9, the characters * and #, and navigation and selection instructions entered at personal voice communication device 202 or read by processor 350 from memory 352.

Operation of an exemplary embodiment of central office 300 to perform call responding method 120 described above with reference to FIG. 2 will now be described with reference to FIG. 2 and FIG. 7. In the example described below, personal voice communication device 202 is in the possession of a recipient and is in wireless communication with a base station (not shown). The base station, in turn, is in communication with central office 300, which serves as an intermediate communication device. The recipient is initially situated in a telephone conversation-inappropriate location, but before entering such location, has provided a user input to personal voice communication device 202 to cause personal voice communication device 202 to provide only a silent user alert. Additionally, the user has provided a user input to personal voice communication device 202 that the personal voice communication device has transmitted to central office 300. Such user input causes central office 300 to execute call responding method 120 in which the courtesy hold process is performed in response to a user input.

In central office 300, processor 350 executes a program that causes processor 350 to operate in a wait mode in which it waits for one of the following events to occur: the user of personal voice communication device 202 provides a user input to initiate a call, for example; and switch 304 receives an incoming call destined for personal voice communication device 202. Such incoming call includes the telephone number of personal voice communication device 202. In response to the telephone number in the incoming call, processor 350 instructs switch 304 to connect the incoming call to subscriber channel 302 (block 122) and additionally generates an incoming call indication that serves as a user alert in this embodiment. The processor feeds the incoming call indication to system signal module 316 via bus 370. System signal module 316 multiplexes the incoming call indication with other system signals and feeds the resulting multiplexed system signal to multiplexer 312. Multiplexer 312 multiplexes the multiplexed system signal received from system signal module 316 with the digital audio signal received from audio module 314 and imposes the resulting communication signal on subscriber link 380 (block 102). The communication signal imposed on subscriber link 380 passes to personal voice communication device 202. Typically, the incoming call includes caller identification information that additionally passes to personal voice communication device 202 via subscriber link 380.

Additionally, once processor 350 has sent the incoming call indication to personal voice communication device 202 as a user alert, it begins to perform a count-down timer routine that defines the first waiting time. In this example, the first waiting time is additionally the waiting time of the alternative recipient process additionally performed by processor 350. The first waiting time defines the time that the alternative recipient process waits before forwarding the incoming call to a designated alternative recipient. Central office 300 may be pre-programmed with the first waiting time or may provide the user with the ability to select the first waiting time by providing an appropriate user input to personal voice communication device 202. Personal voice communication device 202 then transmits the user input to central office 300. In either alternative, the first waiting time is typically stored in the programmable portion of memory 352. In the event that the count-down timer routine reaches zero without the incoming call being answered, processor 350 performs the alternative recipient routine in which it forwards the incoming call to the designated alternative recipient and discontinues providing the incoming call indication to personal voice communication device 202.

At personal voice communication device 202, the incoming call indication indicates that central office 300 has received a call destined for personal voice communication device 202. The communication signal typically additionally includes the above-mentioned caller identification information. Personal voice communication device 202 receives the communication signal and extracts from it the incoming call indication and, if present, the caller identification information. In response to the incoming call indication, personal voice communication device 202 generates a user-perceptible user alert and, optionally, displays the caller identification information, in a manner similar to that described above (block 124).

Alerted by the user-perceptible user alert that an incoming call has been received, the recipient discreetly looks at the display of personal voice communication device 202 to determine the identity of the caller. The recipient can then decide whether to respond to the incoming call using the courtesy hold process. If the recipient decides to activate the courtesy hold process, the recipient provides the courtesy hold user input to personal voice communication device 202, excuses him/herself from the telephone conversation-inappropriate location and makes for a location where a telephone conversation would be appropriate.

The recipient provides the courtesy hold user input using a courtesy hold user input that constitutes part of personal voice communication device 202, as described above. Alternatively, the recipient provides the courtesy hold user input by inputting a sequence of keystrokes using the keypad of personal voice communication device 202. Providing the user inputs needed to control the courtesy hold process by the recipient inputting a sequence of keystrokes using the keypad of personal voice communication device 202 allows a conventional personal voice communication device to respond to an incoming call using a courtesy hold process provided that such conventional personal voice communication device is in communication with central office 300 or another intermediate communication device equipped to respond to an incoming call using a courtesy hold process.

Regardless of the configuration of the personal voice communication device 202, personal voice communication device 202 transmits a courtesy hold signal generated in response to the courtesy hold user input to central office 300 as a system signal included in the communication signal transmitted by personal voice communication device 202. Central office 300 receives the communication signal from personal voice communication device 202 at subscriber channel 302. In communication system 310, multiplexer 312 receives the communication signal from subscriber link 380 and demultiplexes the communication signal to obtain the multiplexed system signal. System signal module 316 then demultiplexes the multiplexed system signal to obtain the individual system signals, including the courtesy hold signal representing the courtesy hold user input, and outputs the system signals to bus 370.

Processor 350 checks the output of system signal module 316 via bus 370 to determine whether a courtesy hold signal is present (block 126). As noted above, the courtesy hold signal can be a courtesy hold user input-specific system signal or can be a sequence of system signals representing a sequence of keystrokes input by the recipient. If processor 350 determines that a courtesy hold signal is not present, it additionally checks its countdown timer routine to determine whether the first waiting time has elapsed (block 128). The first waiting time not having elapsed causes processor 350 to check the output of system signal module 316 again to determine whether the courtesy hold signal is present. The first waiting time having elapsed causes processor 350 to revert to its wait mode, described above, to await a user input or a new incoming call (block 122). Processor 350 may additionally check whether the incoming call indication has been discontinued before returning to block 122 to prevent blocks 122, 102, 126 and 128 from being performed again in response to the same incoming call.

Once processor 350 detects the presence of a courtesy hold signal at the output of system signal module 316, it executes the courtesy hold process (block 130). In executing the courtesy hold process, processor 350 provides an answer signal to system signal module 316 via bus 370 and additionally discontinues providing the incoming call indication to system signal module 316. System signal module 316 multiplexes the answer signal with any other system signals that require transmission to generate the multiplexed system signal, removes the incoming call indication from the multiplexed system signal and provides the multiplexed system signal to multiplexer 312. Multiplexer 312 multiplexes the multiplexed system signal output by system signal module 316 with the digital audio signal output by audio module 314 to generate the communication signal and imposes the communication signal on subscriber link 380. The communication signal passes via subscriber link 380 and switch 304 to the central office (not shown) with which the caller's communication device is in communication. The answer signal included in the communication signal effectively answers the incoming call (block 110) and establishes voice communication between central office 300 and the caller. Discontinuing providing the incoming call indication to personal voice communication device 202 establishes voice communication between personal voice communication device 202 and the central office.

After answering the incoming call, processor 350 reads a set of data representing the courtesy hold message from message store 340, feeds the resulting digital audio signal representing the courtesy hold message to audio module 314 via bus 370, and feeds a control signal to the audio module to cause the audio module to feed the digital audio signal to multiplexer 312. Multiplexer 312 multiplexes the multiplexed system signal output by system signal module 316 with the digital audio signal representing the courtesy hold message output by audio module 314 to generate the communication signal and imposes the communication signal on subscriber link 380. The communication signal passes via subscriber link 380 and switch 304 to the central office with which the caller's communication device is in communication (block 114).

Optionally, the courtesy hold message read from message store 340 begins with an audible cue (block 112). Alternatively, processor 350 reads a set of data representing an audible cue from message store 340 and feeds the resulting digital audio signal representing the audible cue to audio module 314 (block 112) prior to reading the set of data representing the verbal message that constitutes the remainder of the courtesy hold message from message store 340 (block 114). This allows processor 350 to precede all verbal messages with the same audible cue.

Processor 350 then performs a hold routine that puts the incoming call temporarily on hold (block 116). Hold routines that put a call on hold at a central office are known in the art and will not be described here. Putting the incoming call temporarily on hold maintains communication between personal voice communication device 202 and the caller via central office 300. Optionally, music is provided to one or both of the caller and recipient while the incoming call is on hold.

Once it has put the incoming call on hold, processor 350 performs a second count-down timer routine to determine a second waiting time. The second waiting time is the time allowed for the recipient to provide a pick-up user input at personal voice communication device 202. The pick-up user input causes central office 300 to take the incoming call off hold and establishes voice communication between recipient and caller. Central office 300 may be pre-programmed with the second waiting time or may provide the user with the ability to select the second waiting time by providing an appropriate user input to personal voice communication device 202 for transmission to central office 300. In either alternative, the second waiting time is typically stored in the programmable portion of memory 352.

Once the recipient has reached a location where a telephone conversation would be appropriate, the recipient provides a pick-up user input using personal voice communication device 202. The recipient provides the pick-up user input using a pick-up user input that constitutes part of personal voice communication device 202, as described above. Alternatively, the recipient provides the pick-up user input by inputting a sequence of keystrokes using the keypad of personal voice communication device 202. As another alternative, the recipient provides the pick-up user input using a conventional call answering key or by opening a personal voice communication device having a clamshell configuration.

Regardless of the way in which the user provides the pick-up user input at personal voice communication device 202, personal voice communication device 202 transmits a pick-up signal generated in response to the pick-up user input to central office 300 as a system signal included in the communication signal transmitted by personal voice communication device 202. Central office 300 receives the communication signal from personal voice communication device 202 at subscriber channel 302. In communication system 310, multiplexer 312 receives the communication signal from subscriber link 380 and demultiplexes the communication signal to obtain the multiplexed system signal. System signal module 316 then demultiplexes the multiplexed system signal to obtain the individual system signals, including the pick-up signal representing the pick-up user input, and outputs the system signals to bus 370.

Processor 350 checks the output of system signal module 316 via bus 370 to determine whether a pick-up signal is present (block 132). Alternatively, processor 350 may begin checking for whether the pick-up user input has been received as soon as determines that the courtesy hold user input has been received (YES result in block 126). If processor 350 determines that a pick-up signal is not present, it additionally checks the countdown timer routine to determine whether the second waiting time has elapsed (block 134). If the second waiting time has not elapsed, processor 350 checks the output of system signal module 316 again, typically after a delay, to determine whether the pick-up signal is present.

Processor 350 determining that the pick-up signal is present at the output of system signal module 316 causes processor 350 to exit its hold routine. This takes the incoming call off hold (block 136). Taking the incoming signal off hold establishes communication between the caller and the recipient.

Once the parties are in communication with one another, a conversation ensues until one of the parties hangs up by operating the end call control on the keypad of his/her personal voice communication device. Personal voice communication device 202 transmits an end call signal to central office 300 as a system signal included in the communication signal transmitted by personal voice communication device 202. Central office 300 receives the communication signal from personal voice communication device 202 at subscriber channel 302. In communication system 310, multiplexer 312 receives the communication signal from subscriber link 380 and demultiplexes the communication signal to obtain the multiplexed system signal. System signal module 316 then demultiplexes the multiplexed system signal to obtain the individual system signals and outputs the system signals, including the end call system signal, to bus 370.

In response to receiving the end call signal from personal voice communication device 202, processor 350 discontinues providing the answer signal (block 142) and returns to its wait state (block 122). Discontinuing the answer signal additionally hangs up on the incoming call. Otherwise, after a delay, processor 350 again checks whether the end call signal has been received (block 142).

The second waiting time elapsing without the pick-up user input being received indicates to processor 350 that the recipient has failed to reach a location where a telephone conversation would be appropriate, or has decided not to take the incoming call (NO result in block 134). Processor 350 then reads a set of data representing an additional courtesy hold message from message store 340, feeds the resulting digital audio signal representing the additional courtesy hold message to audio module 314 via bus 370, and feeds a control signal to the audio module to cause the audio module to feed the digital audio signal to multiplexer 312. Multiplexer 312 multiplexes the multiplexed system signal output by system signal module 316 with the digital audio signal representing the additional courtesy hold message output by audio module 314 to generate the communication signal and imposes the communication signal on subscriber link 380 (block 138). The communication signal passes to the caller via switch 304 to the subscriber channel or trunk channel via which the incoming call was received, and thence to the caller.

At the end of the additional courtesy hold message, processor 350 performs its alternative recipient routine in which it forwards the incoming call to an alternative recipient, for example, a voice mail service (block 140). Processor 350 additionally discontinues the answer signal, which hangs up on the incoming call. Processor 350 then returns to its wait mode (block 122).

Processor 350 may additionally or alternatively be programmed to perform the call responding methods described above with respect with reference to FIG. 3 and FIG. 4.

The example of central office 300 described above with reference to FIG. 7 is merely an example of an intermediate communication device capable of performing a call responding method in accordance with an embodiment of the invention. The call responding methods described herein may be performed by intermediate communication device configurations different from that described. For example, an intermediate communication device embodied as a base station is similar in structure to central office 300 described above but lacks switch 304 and typically has only a single subscriber channel 302. Subscriber link 380 includes an RF module that provides wireless communication between the base station and personal voice communication device 202. Subscriber link 380 is additionally connected to a switched network or a packet-based network via which the base station receives incoming calls destined for personal voice communication device 202. Moreover, analog signals may be substituted for corresponding digital signals.

Embodiments of the invention are described above with reference to examples in which the communication path between caller and recipient includes an intermediate communication device such as a central office or a base station. Other embodiments of the invention are applicable to personal voice communication devices embodied as point-to-point wireless communication devices. A common example of a point-to-point wireless communication device is a Family Radio Service (FRS) walkie-talkie as specified in 47 CFR § 95.191 et seq. Additional types of point-to-point wireless communication device exist to which embodiments of the invention can be applied. Using such point-to-point wireless communication devices, caller and recipient communicate with one another directly: no intermediate communication device is involved. However, an incoming call received using such a device in a radio call-inappropriate location can be as disruptive as an incoming call received in such location using a personal voice communication device that communicates via an intermediate communication device.

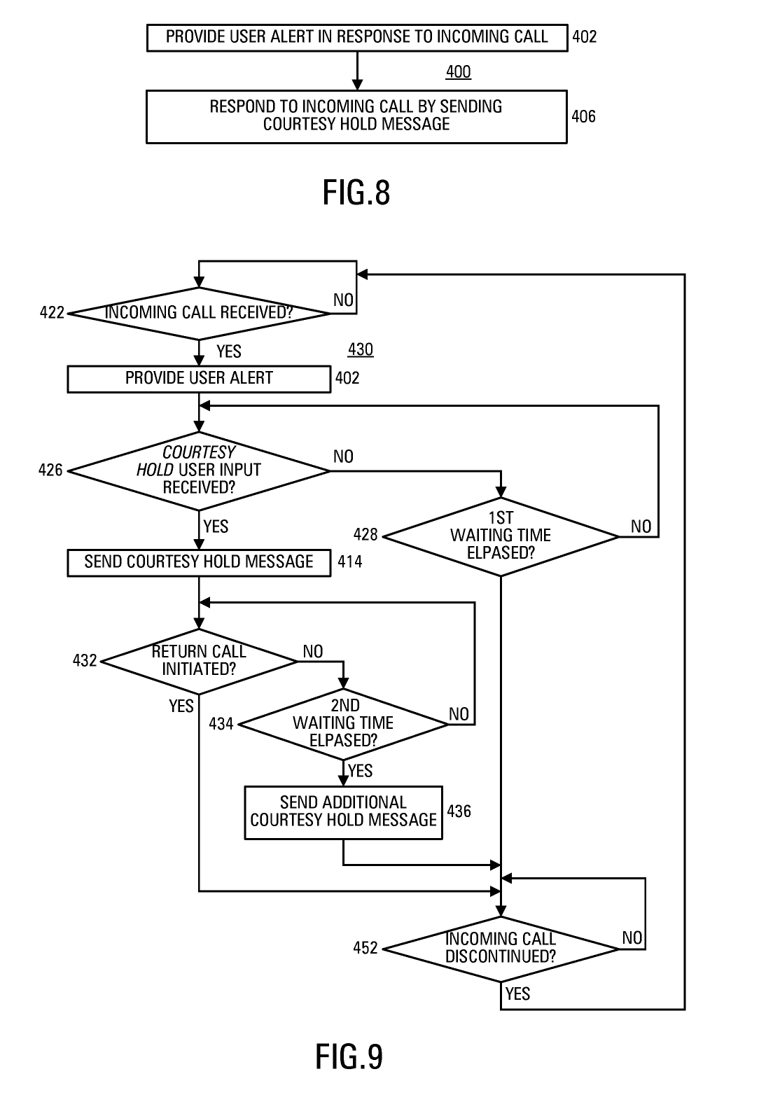

FIG. 8 is a flow chart showing an example of a method a method 400 in accordance with an embodiment of the invention for responding to an incoming call destined for a personal voice communication device embodied as a point-to-point wireless communication device. In block 402, the personal voice communication device provides a user alert in response to the incoming call and, in block 404, the personal voice communication device sends a courtesy hold message in response to the incoming call. An incoming call is a transmission made by a caller using a point-to-point wireless communication device and received by at such point-to-point wireless communication device.

The user alert alerts the recipient to the incoming call so that the recipient can move from the radio call-inappropriate location to a location where a radio call would be appropriate. The courtesy hold message transmitted by the personal voice communication device informs the caller that the recipient is temporarily unavailable and that the caller should expect the recipient to call back shortly. Typically, the courtesy hold message is a verbal message that informs the caller that the recipient is temporarily unavailable, but that the recipient will call the caller back shortly, typically, within one minute; and requests the caller to anticipate receiving a reply shortly. The verbal message may be preceded by an audible cue that identifies the courtesy hold message as such. Alternatively, the audible cue may constitute the entire courtesy hold message, as described above.

In an example, the verbal message that constitutes at least part of the courtesy hold message is worded as follows: “Hello, I'm in a meeting right now and can't talk to you right away, but if you give me 30 seconds, I will find a place where I can talk with you and will call you right back. Please stay tuned to this channel . . . .” The verbal message can be worded differently from this example.

The personal voice communication device embodied as a point-to-point wireless communication device may send the courtesy hold message automatically in response to receiving an incoming call, or in response to a user input in a manner similar to that described above. FIG. 9 is a flow chart showing an example of a method 430 in accordance with an embodiment of the invention in which the personal voice communication device sends the courtesy hold message in response to a user input. Elements of method 430 that correspond to elements of method 400 described above with reference to FIG. 8 are indicated using the same reference numerals and will not be described again here. In the following description, the term call will be used to denote a transmission sent or received by a personal voice communication device embodied as a point-to-point wireless communication device.

Execution begins at block 422, where a test is performed to determine whether an incoming call has been received. A NO result returns execution to block 422, typically after a delay (not shown). A YES result causes execution to advance to block 402.

In block 402, a user alert is provided. As noted above, disruption is minimized when the user alert is a silent user alert. Execution advances to block 426.

In block 426, a test is performed to determine whether a courtesy hold user input has been received. A NO result causes execution to advance to block 428, described next. A YES result causes execution to advance to block 414, described below.

In block 428, a test is performed to determine whether a first waiting time has elapsed. The first waiting time defines the maximum time allowed for the recipient to provide the courtesy hold user input. A NO result causes execution to return to block 426, typically via a delay (not shown). A YES result causes execution to advance to block 452.

In block 452, a test is performed to determine whether the incoming call has been discontinued. A NO result causes execution to return to block 452, typically via a delay (not shown). A YES result causes execution to return to block 422, where the personal voice communication device awaits the next incoming call.

As noted above, a YES result in block 426 indicates that the recipient has provided a courtesy hold user input, and causes execution to advance to block 414. In block 414, a courtesy hold message is sent as a response to the incoming call. In an embodiment, the courtesy hold message is a verbal message at least in part. The verbal message advises the caller that the recipient is temporarily unavailable to take the call, but will be available shortly, and asks the caller to wait for the recipient to return the call. An example of the wording of the verbal message is set forth above, or different wording can be used. An audible cue may precede the verbal message in the courtesy hold message. In a further alternative, the courtesy hold message is a non-verbal message, as mentioned above. Execution then advances to block 432.

In block 432, a test is performed to determine whether a return call has been initiated using the personal voice communication device. A NO result causes execution to advance to block 434, described next. A YES result causes execution to advance to block 452, described above.

In block 434, a test is performed to determine whether a second waiting time has elapsed. The second waiting time defines the maximum time allowed for the recipient to initiate a return call using the personal voice communication device. A NO result causes execution to return to block 432, typically via a delay (not shown). A YES result causes execution to advance to block 436.

In block 436, an additional courtesy hold message is sent. Block 436 is performed when the recipient fails to initiate a return call within the additional predetermined waiting time. The additional courtesy hold message informs the caller that the recipient will not be able to return the incoming call after all. Typically, the additional courtesy hold message is a verbal message at least in part. In the verbal message, the recipient apologizes to the caller for the recipient's failure to return the incoming call and asks the caller to try calling again later. In an embodiment of the additionally courtesy hold message, the verbal message is worded as follows: “I'm sorry, I seem to be unable to exit my meeting. Please try calling me again later. Cheers!” An additional audible cue may precede the verbal message in the additional courtesy hold message or the additional audible cue may constitute the entire additional courtesy hold message similarly to the courtesy hold message. Execution then advances to block 452, described above.

The method described above with reference to FIG. 3 may be adapted in a manner similar to that just described with reference to FIG. 9 to allow the personal voice communication device embodied as a point-to-point wireless communication device to provide the courtesy hold message automatically in response to each incoming call. The method described above with reference to FIG. 4 may be adapted in a manner similar to that just described with reference to FIG. 9 to allow the personal voice communication device embodied as a point-to-point wireless communication device to operate in response to each incoming call to provide the courtesy hold message automatically but with the recipient having an ability to cancel.

An embodiment of a point-to-point wireless communication device-based personal voice communication device in accordance with an embodiment of the invention is similar in structure to personal voice communication device 200 described above with reference to FIG. 5 but differs in that processor 250 is differently programmed and additionally is capable of controlling the operation of RF module 212 to cause the RF module to send at least the courtesy hold message. User input module 260 or keypad 218 includes a transmit key. System signal module 216 generates an incoming call indication indicative of an incoming call. The incoming call indication indicates to processor 250 that an incoming call has been received (block 422, FIG. 9). The recipient operating the above-described transmit key provides a signal to processor 250 via bus 270 that indicates that a return call has been initiated (block 422, FIG. 9).

In some embodiments of a point-to-point wireless communication device-based personal voice communication device, system signal module 216 generates the incoming call indication when it receives a signal greater than a threshold level from RF module 212. In other embodiments, system signal module 216 comprises a squelch circuit that generates the incoming call indication. In a simple implementation, the squelch circuit provides the incoming call indication when it receives from RF module 212 a demodulated signal with signal-to-noise ratio sufficient to allow conversation. A more sophisticated squelch circuit additionally or alternatively looks for a characteristic of the demodulated signal that identifies the caller and provides the incoming call indication accordingly. In an example, the characteristic of the demodulated signal is a sub audible tone, such as the sub audible tone of a continuous tone coded squelch system (CTCSS), included in the demodulated signal. Alternatively, system signal module 216 may incorporate a digital squelch circuit. The more sophisticated squelch circuits are particularly suitable for incorporation in system signal module 216 as they can prevent the courtesy hold message from being sent in response to any incoming call, as could occur with a less sophisticated squelch circuit.

This disclosure describes the invention in detail using illustrative embodiments. However, the invention defined by the appended claims is not limited to the precise embodiments described.

I claim:

1. A method of responding to an incoming call destined for a personal voice communication device, the method comprising:
providing a user alert in response to the incoming call; and
performing a courtesy hold process, comprising:
answering the incoming call,
sending a courtesy hold message as a response to the incoming call, and
putting the incoming call temporarily on hold.

2. The method of claim 1, in which the courtesy hold message is verbal.

3. The method of claim 1, in which the courtesy hold process additionally comprises:
receiving a pick-up user input; and
in response to the pick-up user input, taking the incoming call off hold.

4. The method of claim 1, in which the putting comprises putting the incoming call on hold for no longer than a predetermined time.

5. The method of claim 4, in which the courtesy hold process additionally comprises transferring the incoming call to an alternative recipient after the predetermined time has elapsed.

6. The method of claim 5, in which the alternative recipient is a voice mail service.

7. The method of claim 1, in which:
the method additionally comprises receiving a courtesy hold user input provided in response to the user alert; and
the performing comprises performing the courtesy hold process in response to the courtesy hold user input.

8. The method of claim 7, in which the receiving comprises:
awaiting the courtesy hold user input for a predetermined time; and
forwarding the call to an alternative recipient when no courtesy hold input is received during the predetermined time.

9. The method of claim 8, additionally comprising sending an additional courtesy message prior to the forwarding.

10. The method of claim 1, additionally comprising setting the performing to perform the courtesy hold process automatically in response to each incoming call.

11. The method of claim 10, in which the setting additionally comprises automatically setting the providing to provide the user alert silently.

12. The method of claim 1, in which:
by default, the performing comprises automatically performing the courtesy hold process in response to each incoming call; and
the method additionally comprises:
receiving a courtesy hold cancel user input, and
in response to the courtesy hold cancel user input, inhibiting the automatic performance of the courtesy hold process.

13. The method of claim 1, in which the courtesy hold process additionally comprises displaying caller identification.

14. The method of claim 1, in which the courtesy hold message comprises an audible cue.

15. The method of claim 1, in which:
the personal voice communication device is in signal communication with an intermediate communication device; and
the courtesy hold process is performed by the intermediate communication device.

16. A personal voice communication device, comprising:
a communication system operable to send and receive calls and to provide a user alert in response to an incoming call;
a message store storing data representing a courtesy hold message; and
a processor coupled to the communication system and the message store, the processor operable to cause the communication system to answer the incoming call, to transfer the courtesy hold message from the message store to the communication system, to cause the communication system to send the courtesy hold message as a response to the incoming call, and to cause the communication system to put the incoming call temporarily on hold.

17. The personal voice communication device of claim 16, in which:
the personal voice communication device additionally comprises a user input module operable to receive a pick-up user input; and
the processor is additionally operable in response to the pick-up user input to cause the communication system to take the incoming call off hold.

18. The personal voice communication device of claim 16, in which:
the processor is additionally operable to cause the communication system to put the incoming call on hold for no longer than a predetermined waiting time; and
the processor is additionally operable to cause the communication system to forward the incoming call to an alternative recipient after the predetermined waiting time has elapsed.

19. The personal voice communication device of claim 18, in which the processor is additionally operable to cause the communication system to send an additional courtesy hold message prior to forwarding the incoming call to the alternative recipient.

20. The personal voice communication device of claim 16, in which:
the personal voice communication device additionally comprises a user input module operable to receive a courtesy hold user input; and
the processor is operable in response to the courtesy hold user input to cause the communication system to answer the incoming call, to transfer the courtesy hold message from the message store to the communication system, to cause the communication system to send the courtesy hold message as a response to the incoming call, and to cause the communication system to put the incoming call temporarily on hold.

21. The personal voice communication device of claim 16, in which the processor is operable automatically to cause the communication system to answer the incoming call, to transfer the courtesy hold message from the message store to the communication system, to cause the communication system to send the courtesy hold message as a response to the incoming call, and to cause the communication system to put the incoming call temporarily on hold.

22. The personal voice communication device of claim 21, in which:
the personal voice communication device additionally comprises a silent user alert; and
the processor is additionally operable to cause the communication system to activate only the silent user alert to provide the user alert.

23. The personal voice communication device of claim 16, in which the courtesy hold message is verbal.

24. An intermediate communication device, comprising:
a communication system operable to send and receive a communication signal;
a message store storing data representing a courtesy hold message; and
a processor coupled to the communication system and the message store, the processor operable to cause the communication system to answer an incoming call, to transfer the courtesy hold message from the message store to the communication system, to cause the communication system to send the courtesy hold message as a response to the incoming call, and to cause the communication system to put the incoming call temporarily on hold.

25. The intermediate communication device of claim 24, in which:
the communication system is additionally operable to receive a pick-up signal in response to a pick-up user input provided at a personal voice communication device in signal communication with the intermediate communication device; and
the processor is additionally operable in response to the pick-up signal to cause the communication system to take the incoming call off hold.

26. The intermediate communication device of claim 25, in which the pick-up user input comprises a sequence of keystrokes.

27. The intermediate communication device of claim 24, in which:
the processor is additionally operable to cause the communication system to put the incoming call on hold for no longer than a predetermined waiting time; and
the processor is additionally operable to cause the communication system to forward the incoming call to an alternative recipient after the predetermined waiting time has elapsed.

28. The intermediate communication device of claim 27, in which the processor is additionally operable to cause the communication system to send an additional courtesy hold message prior to forwarding the incoming call to the alternative recipient.

29. The intermediate communication device of claim 24, in which:
the communication system is additionally operable to receive a courtesy hold signal in response to a courtesy hold user input provided at a personal voice communication device in signal communication with the intermediate communication device; and
the processor is operable in response to the courtesy hold signal to cause the communication system to answer the incoming call, to transfer the courtesy hold message from the message store to the communication system, to cause the communication system to send the courtesy hold message as a response to the incoming call, and to cause the communication system to put the incoming call temporarily on hold.

30. The intermediate communication device of claim 24, in which the processor is operable automatically to cause the communication system to answer the incoming call, to transfer the courtesy hold message from the message store to the communication system, to cause the communication system to send the courtesy hold message as a response to the incoming call, and to cause the communication system to put the incoming call temporarily on hold.

31. The intermediate communication device of claim 24, in which the courtesy hold message is verbal.

32. A personal voice communication device capable of communicating with the intermediate communication device of claim 24 and structured to provide to the communication system a courtesy hold signal in response to which the processor causes the communication system to answer the incoming call, transfers the courtesy hold message from the message store to the communication system, causes the communication system to send the courtesy hold message as a response to the incoming call and causes the communication system to put the incoming call temporarily on hold.

33. A personal voice communication device capable of communicating with the intermediate communication device of claim 24 and structured to provide to the intermediate communication device a pick-up signal in response to which the processor additionally causes the communication system to take the incoming call off hold.

34. The personal voice communication device of claim 33, comprising a user input module operable to generate the pick-up signal in response to a user input.

35. A method of responding to an incoming call destined for a personal voice communication device, the method comprising:
providing a user alert in response to the incoming call; and
sending a courtesy hold message indication as a response to the incoming call.

36. The method of claim 35, in which:
the method additionally comprises receiving a courtesy hold user input provided in response to the user alert; and
the sending comprises sending the courtesy hold message in response to the courtesy hold user input.

37. The method of claim 35, in which the sending is performed automatically in response to each incoming call.

38. The method of claim 35, additionally comprising:
determining whether a return call has been initiated within a predetermined waiting time; and
when the determining determines that the return call has not been initiated within the predetermined waiting time, sending an additional courtesy hold message.
